(19) United States
(12) Patent Application Publication
(10) Pub. No.: US 2007/0063499 A1
(43) Pub. Date: Mar. 22, 2007

(54) Anti-tilting suspension for an electric motorcycle

(76) Inventor: Chun-Pi Shem, Yung Kang City (TW)

Correspondence Address: Chun - PI SHEM, P.O. BOX 90, Tainan City, 70499, TW

(21) Appl. No.: 11/228,276

(22) Filed: Sep. 19, 2005

(51) Int. Cl. B62D 49/08; B60K 1/00

(52) U.S. Cl. 280/755; 180/216; 180/65.1; 180/907

(57) ABSTRACT

An anti-tilting suspension for an electric motorcycle includes a main framework, a front wheel, a driving device and two rear wheels. The main framework is provided with an upper suspension at its two sides respectively. Each the upper suspension is set with a pivot connection frame at its one end. The driving device has a shaft and an interactive arm. One end of the interactive arm is pivotally connected with the pivot connection frame. The shaft of the driving device is provided with two matching part for matching with a matching frame at the other end of each interacting arm. Each rear wheel has a suspension arm and the suspension arm has a roller at its front end. Therefore, the electric motorcycle is able to cope with various situations of roads with an anti-tilting effect.

### BACKGROUND OF THE INVENTION

1. Field of the Invention

This invention relates to an anti-tilting suspension for an electric motorcycle, particularly to one that includes a main framework, a front wheel, a driving device and two rear wheels. The main framework is provided with an upper suspension at its two sides respectively. Each upper suspension is set with a pivot connection frame at its one end. The driving device is provided with a shaft and an interactive arm at two sides of the main framework respectively. One end of the interactive arm is pivotally connected with the pivot connection frame. The shaft of the driving device is provided with a matching part at two sides of the main framework respectively for matching with a matching frame at the other end of the interactive arm. Each of the rear wheels has a suspension arm extending outward and the suspension arm has a roller at its front end. Therefore, the electric motorcycle, provided with independent suspensions for the driving device and the rear wheels, is able to cope with various situations of a road while running and to achieve an anti-tilting effect.

2. Description of the Prior Art

Usually, a conventional electric motorcycle is provided for those who are the old or the disabled to use as their regular means instead of walking. The main framework of the conventional one is always formed integrally and designed to have a front and a rear wheel at the same side or the front ones or the rear ones being linked together because it's easy to design. When the conventional one runs on a smooth flat road, of course, it is able to run steadily and smoothly. But, if it encounters other situations, such as a hump or a cavity, it may tilt or, if worse, turn over to cause danger, due to an improper suspension provided.

### SUMMARY OF THE INVENTION

The prime object of this invention is to offer an anti-tilting suspension for an electric motorcycle for the sake of safety.

The main characteristics of the invention are a main framework, a front wheel, a driving device and two rear wheels. An upper suspension is set at the rear side and two sides of the main framework respectively and provided with a pivot connection frame at its one end. The driving device possesses an interactive arm at two sides of the main framework respectively and a shaft provided with a matching part at two sides of the main framework respectively. One end of the interactive arm is matched with the pivot connection frame and the other end is provided with a matching frame for matching with the matching part of the shaft. Each rear wheel has a suspension arm extending forwards, and the suspension arm has a roller at its front end.

### BRIEF DESCRIPTION OF DRAWINGS

This invention is better understood by referring to the accompanying drawings, wherein:

FIG. 1 is an exploded perspective view of a preferred embodiment of an anti-tilting suspension for an electric motorcycle in this invention;

FIG. 2 is a perspective view of the preferred embodiment of an anti-tilting suspension for an electric motorcycle in this invention;

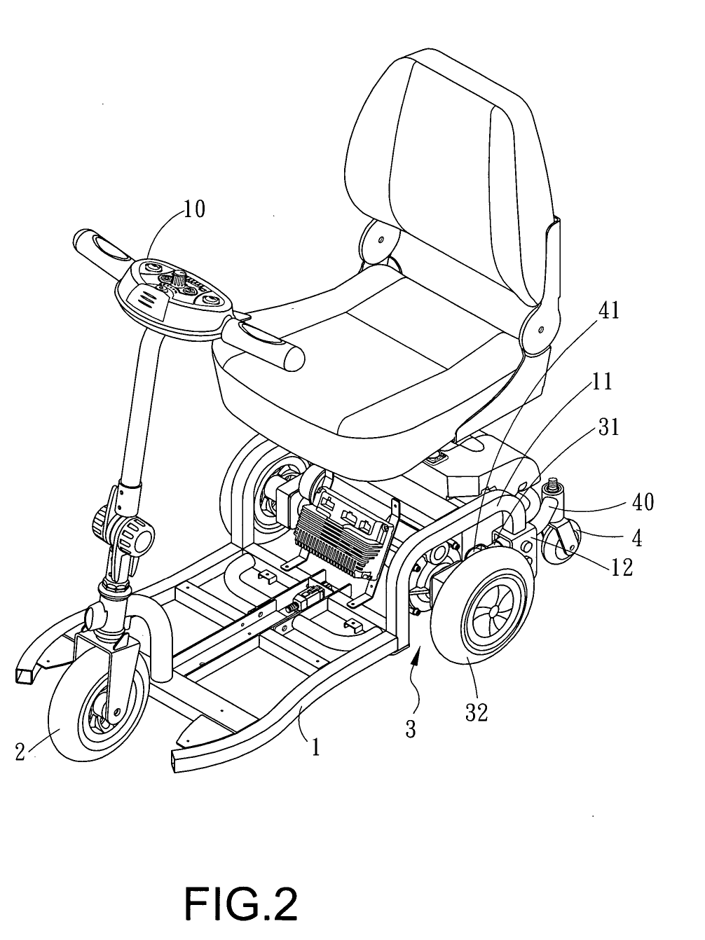

FIG. 3 is a perspective side-view of the preferred embodiment of an anti-tilting suspension for an electric motorcycle in this invention;

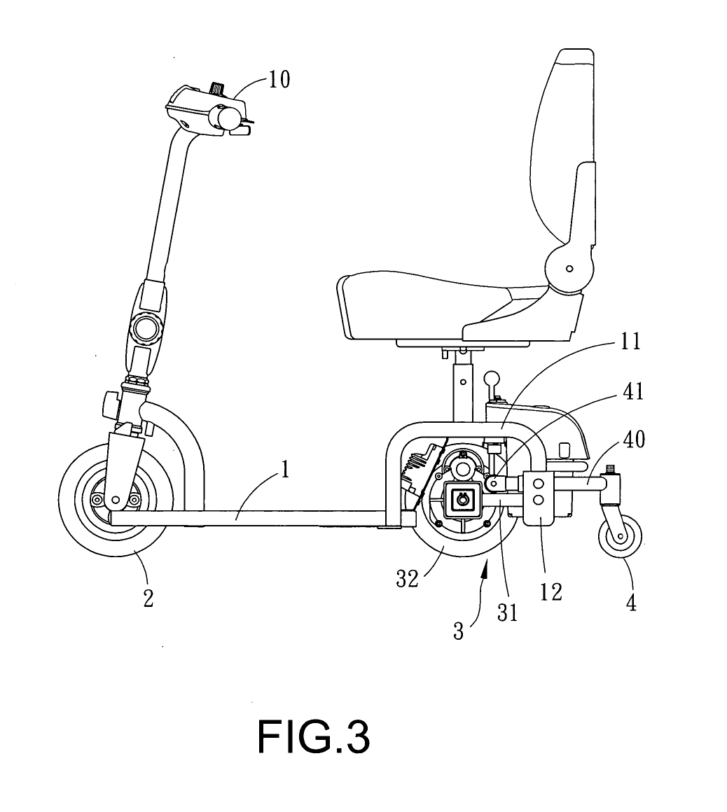

FIG. 4 is a perspective view of the preferred embodiment of an anti-tilting suspension for an electric motorcycle in this invention, showing it under running over a hump;

FIG. 5 is a perspective view of a preferred embodiment of an anti-tilting suspension for an electric motorcycle in this invention, showing it under running on a cavity abutting to a hump; and

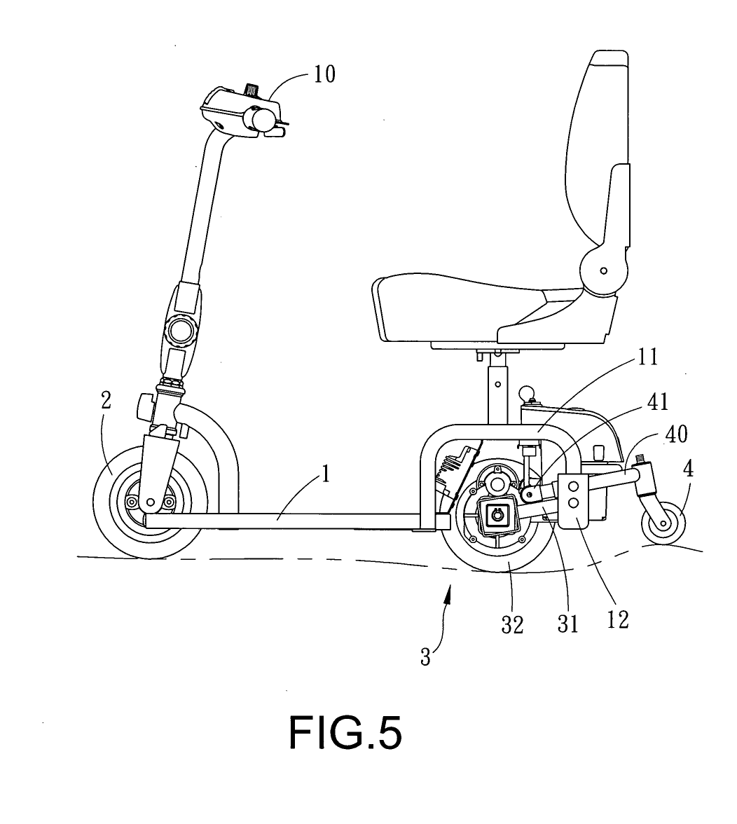

FIG. 6 is a perspective view of a preferred embodiment of an anti-tilting suspension for an electric motorcycle in this invention, showing it under running on a flat ground abutting to a cavity.

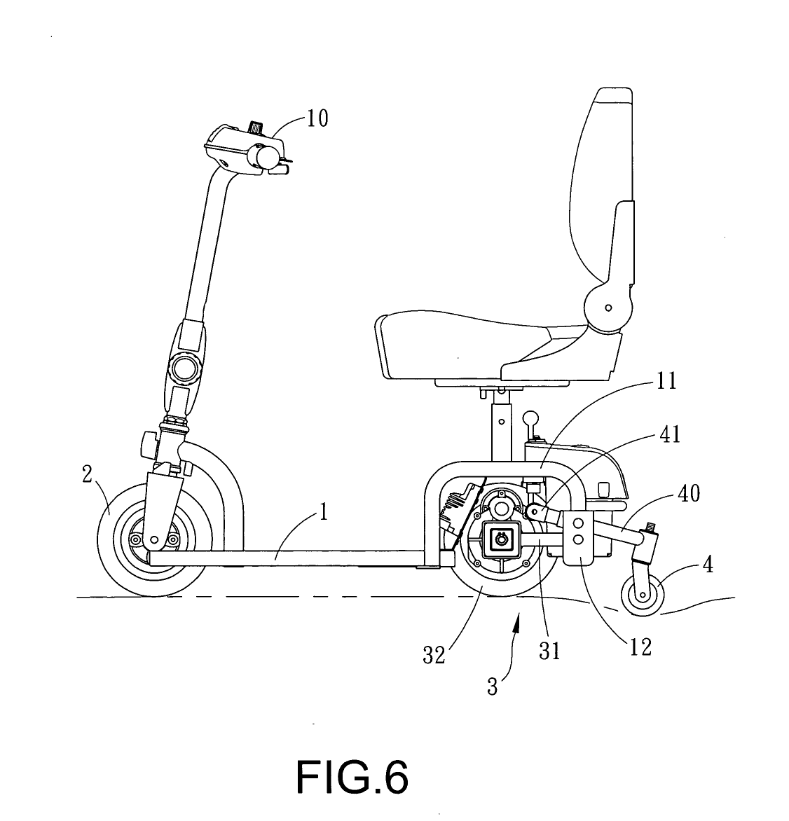

### DETAILED DESCRIPTION OF THE PREFERRED EMBODIMENT

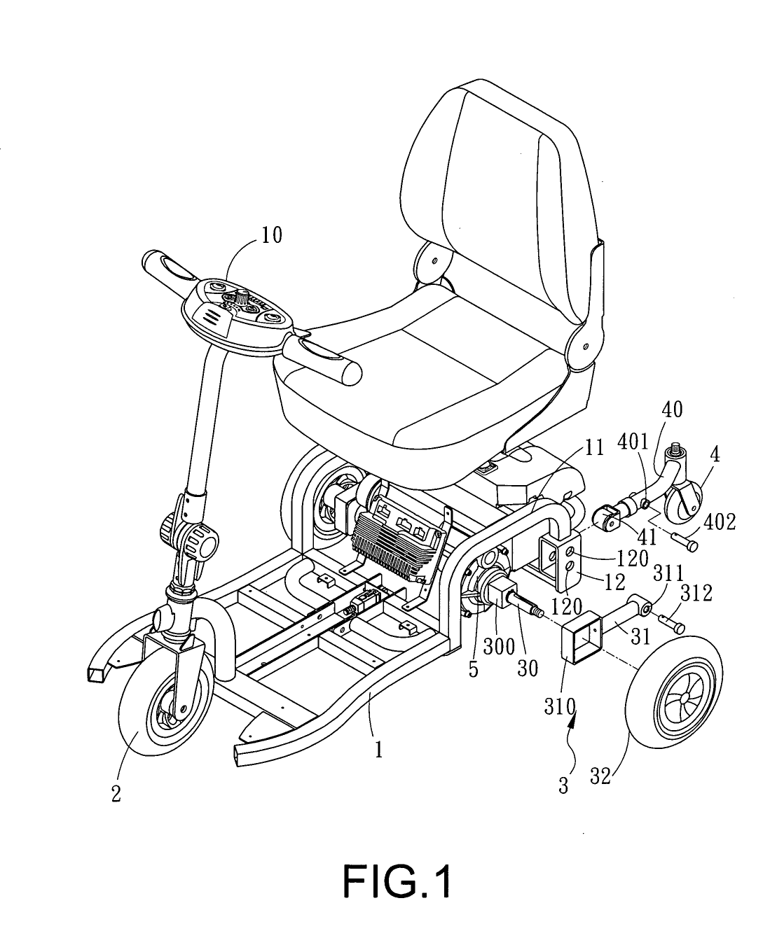

First, as shown in FIGS. 1,2 and 3, a preferred embodiment of an anti-tilting suspension system for an electric motorcycle includes a main framework 1, a front wheel 2, a driving device 3 and two rear wheels 4.

The main framework 1 is provided with a handle 10 at the top of its front side and an upper suspension 11 shaped similar to an inverted U-shape at two sides of the rear portion respectively. The rear end of each the upper suspensions 11 is set with a pivot connection frame 12 having two pivot holes on its two sides respectively and facing each other.

The front wheel 2 is set at the front side of the main framework 1 and controlled by the handle 10.

The driving device 3 is set in the rear side of the main framework 1, composed of a shaft 30, an interactive arm 31 and a driving wheel at two sides of the main framework 1 respectively. The shaft 30 is assembled to extend to two sides of a differential 5 and possesses a matching part 300 at its outer portion for matching with the interactive arm 31. The interactive arm 31 is provided with a matching frame 310 at its one end for matching with the matching part 300, and a pivot hole 311 at its other end to correspond to the lower pivot hole 120 of the pivot connection frame 12 for a pivot 312 to pass through. The driving wheel 32 is assembled at the outmost portion of the shaft 30 for driving the front wheel 2 and the rear wheel 4.

The rear wheels 4 are assembled with the rear portion of the main framework 1, respectively provided with a suspension arm 40 extending forwards, which has a roller 41 at its front end. The suspension arm 40 is provided with a pivot hole 401 vertically, corresponding to the upper pivot hole 120 of the pivot connection frame 12 for a pivot 402 to pass through. Therefore, the suspension 41 of the rear wheel 40 is able to swing pivotally on the upper suspension 11 of the main framework 1.

In assembling, as shown in FIGS. 1,2 and 3, keep the matching frame 310 matched with the matching part 300 of the shaft 30 first and then, combine the driving wheel 32 with the outmost portion of the shaft 30 and keep the pivot hole 311 at the other end of the interactive arm 31 facing to the lower pivot hole 120 of the pivot connection frame 12 just exactly. Next, make the pivot 312 to pass through the lower pivot hole 120 and the pivot hole 311 orderly. Then the suspension arm 40 of the rear wheel 4 is extended through the pivot connection frame 12 forwards to let the roller 41 of the suspension 40 respond to the interactive arm 31 of the driving device 3 and the pivot hole 401 of the suspension 41 face exactly to the upper bolt hole 120 of the bolting frame 12. Then, put the pivot 402 through the upper pivot hole 120 and the pivot hole 401 orderly. Therefore, the electric motorcycle has the structure of each rear wheel 4 independent from that of each driving wheel 32 of the driving device 3, with no direct linking between them, having both suspension and anti-tilting effects.

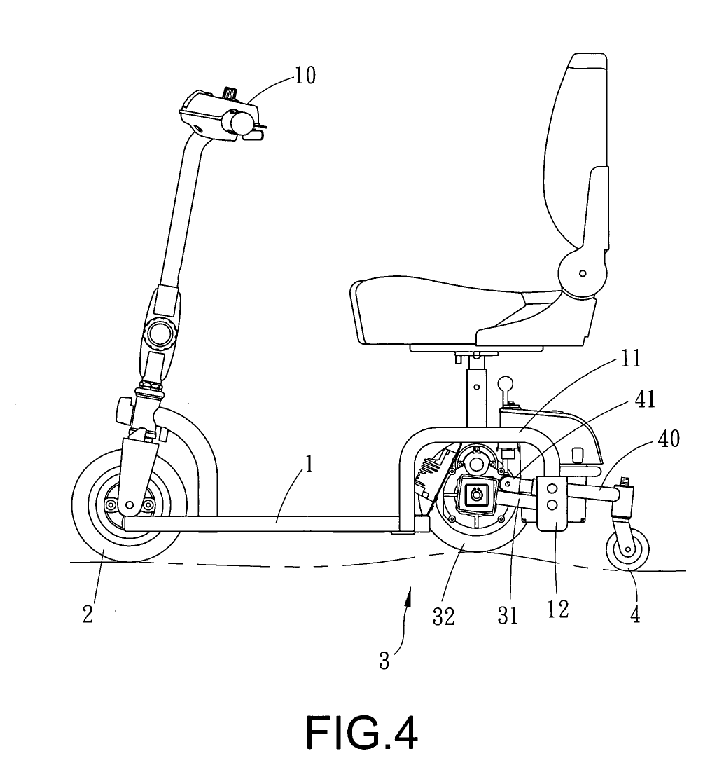

In using, as shown in FIGS. 4,5 and 6, they depict various situations possible for an electric motorcycle in this invention to encounter while running on a road. If the motorcycle happens to run over a hump or a cavity only by one of the driving wheels 32, the roller 41 coordinates with the interactive arm 31 of the driving device 3 and with the suspension arm 40 pivotally connected with the pivot connection frame 12, possible to rise up or move down simultaneously as the interactive arm 31 does. Then the rear wheels 4 and the driving wheels 32 can run over the hump or the cavity, contacting with the ground absolutely and achieving a smooth and steady drive. Or, if one of the rear wheels 4 only runs over a cavity, the rear wheel 4 pivotally connected with the pivot connection frame 12 by means of the suspension arm 40 is to swing vertically against the upper suspension 11, making the end of the roller 41 raised up and the rear wheel 4 still kept contact with the ground as usual. Meanwhile, the driving wheel 32 still contacts with the ground without suspending in air. Therefore, the driving wheel 32 and the rear wheel 4 running over the cavity, can still touch on the ground, providing a smooth and steady drive as well.

Additionally, since the rear wheels 4 are provided with a pivotal swinging system against the main framework 1, forming an independent suspension system and able to be driven by the driving device 3, they can be set at the inside or the bottom of the main framework 1 as long as they respond to the driving device 3.

Conclusively, various merits of this invention are listed as below:

1. The driving wheels of the driving device and the rear wheels of an electric motorcycle in this invention have their own independent suspension, enabling the motorcycle to run smoothly and steadily, even if it encounters a hump or a cavity.

2. An electric motorcycle in this invention is provided with a swinging effect of the rear wheels against the main framework and the interactive design between the suspension arm and the interactive arm, able to automatically adjust the angle of the rear wheels, responding to the road situation, keeping all wheels always in contact with the ground and accordingly preventing the rear wheels from tilting.

3. Since all relative suspensions of an electric motorcycle in this invention are independent from one another, the motorcycle can reduce its radius of gyration because it can use a single driving wheel to grab the ground at one spot to carry out turn-around, without possibility of turning itself over.

While the preferred embodiment of the invention has been described above, it will be recognized and understood that various modifications may be made therein and the appended claims are intended to cover all such modifications that may fall within the spirit and scope of the invention.

What is claimed is:

1. An anti-tilting suspension for an electric motorcycle comprising:
a main framework having a handle at the top of its front end and an upper suspension at its rear at its two sides of its rear portion respectively, each said upper suspension provided with a pivot connection frame at its one end;
a front wheel set at a front side of said main framework and controlled by said handle;
a driving device set at the rear side of said main framework and possessing a shaft assembled with a driving wheel at its outmost portion at two sides of said main framework respectively and an interactive arm and having one end pivotally connected with said pivot connection frame, said shaft having a matching part for matching with a matching frame provided at the other end of said interactive arm;
two rear wheels respectively set at two sides behind said main framework, each said rear wheel having a suspension arm extending forwards, said suspension arm having a roller at its front end; and
said driving device and said rear wheels arranged independently from each other so that it is able to run on a road smoothly and steadily even if the road has a hump or a cavity, gaining an anti-tilting effect.

2. An anti-tilting suspension for an electric motorcycle as claimed in claim 1, wherein said pivot connection frame of said main framework is bored with plural pivot holes.

3. An anti-tilting suspension for an electric motorcycle as claimed in claim 1, wherein said interactive arm is provided with a pivot hole at its one end for pivotally connecting with said pivot connection frame of said main framework.

4. An anti-tilting suspension for an electric motorcycle as claimed in claim 1, wherein said suspension arm of said each rear wheel is bored with a pivotal hole for pivotally connecting with said pivot connection frame, enabling said each rear wheel to swing vertically against said upper suspension of said main framework.
